(19) United States
(12) Patent Application Publication
(10) Pub. No.: US 2013/0148493 A1
(43) Pub. Date: Jun. 13, 2013

(54) Providing an Alternative Media Channel in a Virtual Media System

(71) Applicants: Michael Keenan, Stittsville (CA); Ted Youel, Edina, MN (US); Bryan Katz, Freehold, NJ (US)

(72) Inventors: Michael Keenan, Stittsville (CA); Ted Youel, Edina, MN (US); Bryan Katz, Freehold, NJ (US)

(73) Assignee: AVAYA INC., Basking Ridge, NJ (US)

(21) Appl. No.: 13/324,103

(22) Filed: Dec. 13, 2011

(51) Int. Cl. H04L 12/26

(52) U.S. Cl. 370/225

(57) ABSTRACT

A virtual communication channel is established between a virtual server and a virtual controller. The virtual communication channel can support one or more media communications, such as audio, voice, and text communications. The virtual controller determines that the virtual communication channel cannot be sustained. In response to determining that the virtual communication channel cannot be sustained, a media controller provides an alternative communication channel. The alternative communication channel is used to provide the one or more media communications.

### TECHNICAL FIELD

The system and method relates to virtual desktop integration and in particular to providing alternative media channels in a virtual desktop environment.

### BACKGROUND

Currently, there is a trend to provide a variety of services via cloud computing. One of these services provides Virtual Desktop Integration (VDI). VDI is the ability to provide a virtual desktop to a low-cost virtual desktop device while providing the processing power of the desktop in the network. In addition to low cost, VDI also provides other benefits, such as security of information and backup services.

VDI can be used to virtualize a desktop operating system. For example, the Windows® operating system from Microsoft can be provided in a VDI environment. In this example, the Windows® operating system is running on a virtual server on the network and the virtual desktop provides a virtual display of the Windows® platform to a user.

In today's environment, the desktop includes a variety of media services, such as voice communications, video communications, and text communications. Communications for these media services are provided via the virtual desktop. One problem with current VDI solutions is that when the virtual server goes down or communication channel to the virtual server goes down, the user is unable to access these media services. Not being able to access media communications can be problematic when emergency situations arise that require access to emergency services, such as the ability to make a 911 call. What is needed is a solution to provide an alternative method of access to media services when access to virtual services cannot be achieved.

### SUMMARY

The system and method are directed to solving these and other problems and disadvantages of the prior art. A virtual communication channel is established between a virtual server and a virtual controller. The virtual communication channel can support one or more media communications, such as audio, voice, and text communications. The virtual controller determines that the virtual communication channel cannot be sustained. In response to determining that the virtual communication channel cannot be sustained, a media controller provides an alternative communication channel. The alternative communication channel is used to provide the one or more media communications.

Determining that the virtual communication channel cannot be sustained can be accomplished in a variety of ways, including, but not limited to, determining that the virtual communication channel went down, determining that the virtual communication cannot be established, and/or determining that the virtual communication is down by not being able to establish the media communication.

An alternative communication interface is provided that allows a user to initiate media communications in the alternative communication channel. The alternative communication interface can include push-to-talk buttons that allow the user to call a help desk, generate a trouble ticket, make a 911 call, and/or make an emergency call. Other embodiments include providing the user with a keypad to make audio and video communications.

In addition to audio and video communications, the user is provided with the ability to make text communications on the alternative communication channel. Regular communications can also be made using a caller ID list and saved user information.

Other embodiments allow for media communications that were previously created in the virtual communication channel to be reestablished when the virtual communication channel cannot be sustained. Moreover, a communication that was established in the alternative communication channel can be reestablished in the virtual communication channel when the virtual communication channel is reestablished.

Still other embodiments provide a continued media communication window that gives a user the ability to reestablish the media communication in the alternative communication channel.

### BRIEF DESCRIPTION OF THE DRAWINGS

In order to describe the manner in which other advantages and features of the disclosure can be obtained, a more particular description of the principles and the best mode briefly described below will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a first illustrative system for providing an alternative communication channel in a virtual environment.

FIG. 2 is a block diagram of a second illustrative system for providing an alternative communication channel in a virtual environment.

FIG. 3A is a diagram of an exemplary alternative communication interface.

FIG. 3B is a diagram of another exemplary alternative communication interface.

FIG. 4 is a flow diagram of a method for providing an alternative communication channel in a virtual environment.

FIG. 5 is a flow diagram of a method that automatically re-establishes a media communication once the virtual communication channel is re-established.

In the appended Figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The following description and associated Figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

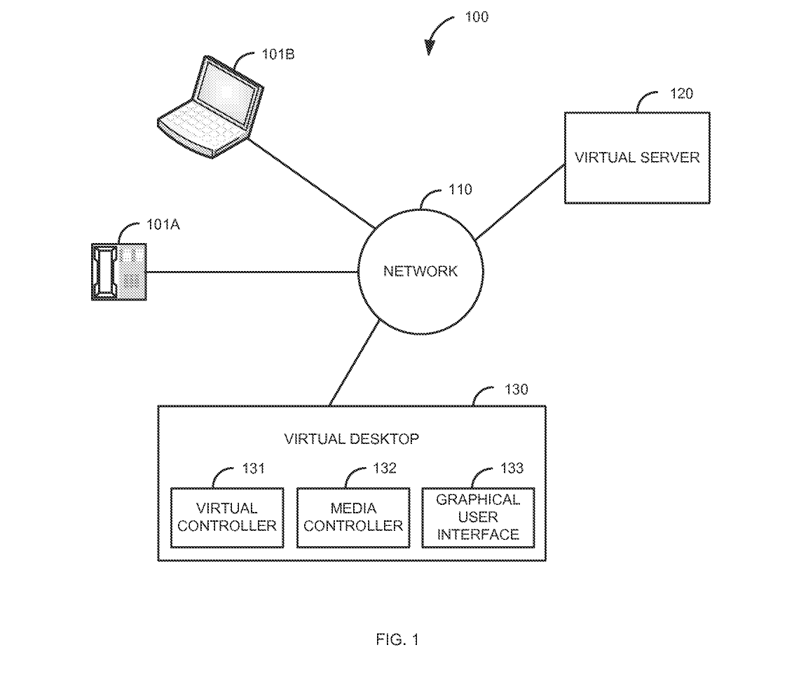

FIG. 1 is a block diagram of a first illustrative system 100 for providing an alternative communication channel in a virtual environment. The first illustrative system 100 comprises communication devices 101A-101B, network 110, virtual server 120, and virtual desktop 130. Communication devices 101A-101B can be any type of communication device that can communicate on network 110, such as a Personal Computer (PC), a telephone, a cellular telephone, a Personal Digital Assistant (PDA), a smart phone, a laptop computer, and the like. In FIG. 1, only two communication devices 101A and 101B are shown for simplification. However, any number of communication devices 101 can be attached to network 110.

Network 110 can be any type of network, such as the Public Switched Telephone Network (PSTN), a cellular network, a corporate network, a Local Area Network (LAN), a Wide Area Network (WAN), the Internet, a wireless network, a wired network, a fiber optic network, any combination of these, and the like. Network 110 can further comprise network elements, such as telephone communication systems, video communication systems, mail servers, Instant Messaging (IM) servers, cellular network hardware, Private Branch Exchanges (PBXs), routers, video servers, media servers, various combinations of these, and the like. Network 110 can provide a variety of services, such as telephony services, video services, email services, IM services, and the like, between communication devices 101A-101B and virtual server 120 and/or virtual desktop 130.

Virtual server 120 can be any device or combination of devices that provide virtual services. Virtual server 120 can be a server, a cluster of servers, and the like. Virtual server 120 can provide a variety of virtual services, such as Virtual Desktop Integration (VDI), virtual applications, virtual disk drives, and the like. Virtual server 120 can provide virtualization of various types of operating systems (and supported applications), such as Linux®, Microsoft Windows®, and the like. Moreover, virtual server 120 can provide virtualized applications. For example, virtual server 120 can provide a virtualized spread sheet, an email application, video conferencing software, a soft telephone, and the like, that is virtualized on a standard PC.

Virtual desktop 130 can be any type of communication device that can communicate with virtual server 120, such as a Personal Computer (PC), a specialized virtual communication device, a mobile device, and the like. Virtual desktop 130 can be a specialized communication device that comprises specialized processors, memory, and software to provide virtualization services. Virtual desktop 130 can comprise an operating system, such as Linux®, which is used to provide the virtualized view of the operating system running on the virtual server 120 (e.g., a Windows® operating system).

Virtual desktop 130 further comprises virtual controller 131, media controller 132, and Graphical User Interface (GUI) 133. Virtual controller 131 can be any hardware/software that can provide a virtualized desktop via a virtual channel. Virtual controller 131 can comprise hardware/software to communicate with network 110 and virtual server 120. Virtual controller 131 can provide media services via the virtual communication channel from video server 120. For example, virtual controller 131 can provide virtualized voice, video, and text communications via the virtual communication channel. The virtual communication channel can be a communication channel for a full virtual desktop integration and/or for one or more applications that run on virtual desktop 130.

Media controller 132 can be any hardware/software that can create media sessions external to the virtual channel. Media controller 132 can comprise hardware/software to communicate with network 110. For example, media controller 132 can provide media sessions, such as audio/video communications via Session Initiation Protocol (SIP) with services in network 110; for instance, a SIP communication can be established via a SIP proxy server and/or a SIP Private Branch Exchange (PBX) to set up a SIP communication with communication devices 101A and/or 101B. Instead of using SIP, other communication methods, such as H.323, SMTP, various video communication protocols, and the like can be used to establish a media session.

Graphical User Interface (GUI) 133 can be any hardware/software that provides a graphical user interface to a user of virtual desktop 130. Graphical user interface 133 can be a separate device, such as a monitor, or can be integrated into virtual desktop 130. Graphical user interface 133 can be a Liquid Crystal Display (LCD), a plasma display, a Cathode Ray Tube (CRT), and the like. Graphical user interface 133 can include additional software, such as software drivers for displaying information in graphical user interface 133.

Virtual controller 131 establishes a virtual communication channel between virtual controller 131 and virtual server 120. The virtual communication channel also provides the ability to support media communications, such as audio communications, video communications, and text communications. At some point, a media communication is set up between virtual desktop 130, virtual server 120, and a communication device 101.

To illustrate how a media communication can be established, consider the following example. After the virtual communication has been established between virtual server 120 and virtual desktop 130, a user selects a video conferencing application that is displayed in graphical user interface 133. The user elects to set up a video conference with the user at communication device 101B. The selections are conveyed via the virtual communication channel to virtual server 120. Virtual server 120 creates a video communication channel to communication device 101B. Once the video communication channel is established, communication device 101B streams a video stream to virtual server 120, which in turn sends the video stream to virtual desktop 130. The received video stream is displayed in graphical user interface 133. Likewise, a video stream (captured by a video camera (not shown)) is sent from virtual desktop 130 via the virtual communication channel to virtual server 120, which in turn sends the video stream to communication device 101B.

Virtual controller 131 determines that the virtual communication channel cannot be sustained. The virtual communication channel may not be sustained for a variety of reasons, such as virtual server 120 failing, the connection to network 110 from virtual server 120 going down, network failures, and the like. Virtual controller 131 can determine that the virtual communication cannot be sustained in a variety of ways. For example, virtual controller 131 can determine that the virtual communication channel went down, determine that the virtual communication channel cannot be established, determine that the virtual communication channel is down by not being able to establish the media communication, determine a loss of signaling on the virtual communication channel or other signaling channel, and the like.

In response to determining that the virtual communication channel cannot be sustained, media controller 132 provides an alternative communication channel for the media communication. Providing an alternative communication channel can be accomplished in a variety of ways. For example, media controller 132 can communicate with a SIP proxy server (not shown) in network 110 to provide video or audio communications when necessary. Likewise, media controller 132 can provide Instant Messaging (IM) communications via an IM server (not shown) in network 110. Providing the alternative communication channel can also include setting up a video or audio communication/conference with communication devices 101A and/or 101B. Providing an alternative communication channel does not necessarily include establishing a media session—just providing access to establish a media communication when needed.

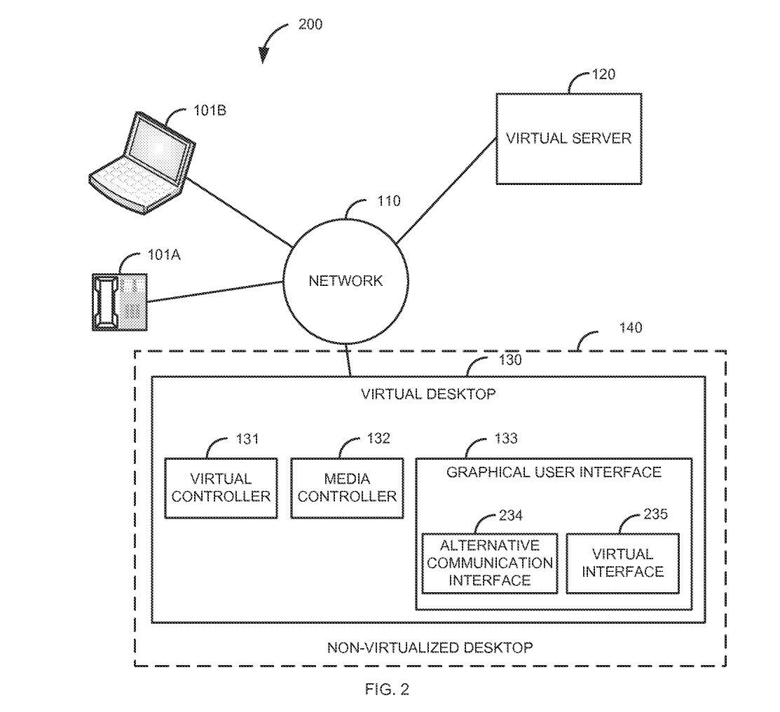

FIG. 2 is a block diagram of a second illustrative system for providing an alternative communication channel in a virtual environment. FIG. 2 further comprises alternative communication interface 234 and virtual interface 235. Alternative communication interface 234 and virtual interface 235 are shown as part of graphical user interface 133. In this illustrative example, alternative communication interface 234 and virtual interface 235 are shown in a single graphical user interface 133. However, alternative communication interface 234 and virtual interface 235 may be in different graphical user interfaces 133. Alternative communication interface 234 allows a user to establish media communications via the alternative communication channel. Virtual interface 235 is a visual representation of the virtualized operating system running in virtual server 120. For example, virtual interface 235 may be presenting a virtualized interface of the Windows® or Linux® operating system that is running on virtual server 120.

FIG. 2 also shows non-virtualized desktop 140. Non-virtualized desktop 140 can be optionally used in environments where virtual server 120 only provides virtualized application(s). The virtualized application(s) are provided to the user via virtual desktop 130 that is running on non-virtualized desktop 140. For example, a virtualized video conferencing application is provided by virtual server 120 via virtual desktop 130 (where Windows® runs virtual desktop 130).

Virtual controller 131 establishes a virtual communication channel between virtual controller 131 and virtual server 120. Once the virtual communication channel is established, a user of virtual desktop 130 is presented with virtual interface 235.

Virtual controller 131 determines that the virtual communication channel cannot be sustained. In response to determining that the virtual communication channel cannot be sustained, media controller 132 provides an alternative communication channel for media communication(s). The user of virtual desktop 130 can access the alternative communication channel via alternative communication interface 234. Alternative communication interface 234 allows the user to establish different types of media communication on the alternative communication channel. For example, the user can make an emergency call or a 911 call using alternative communication interface 234.

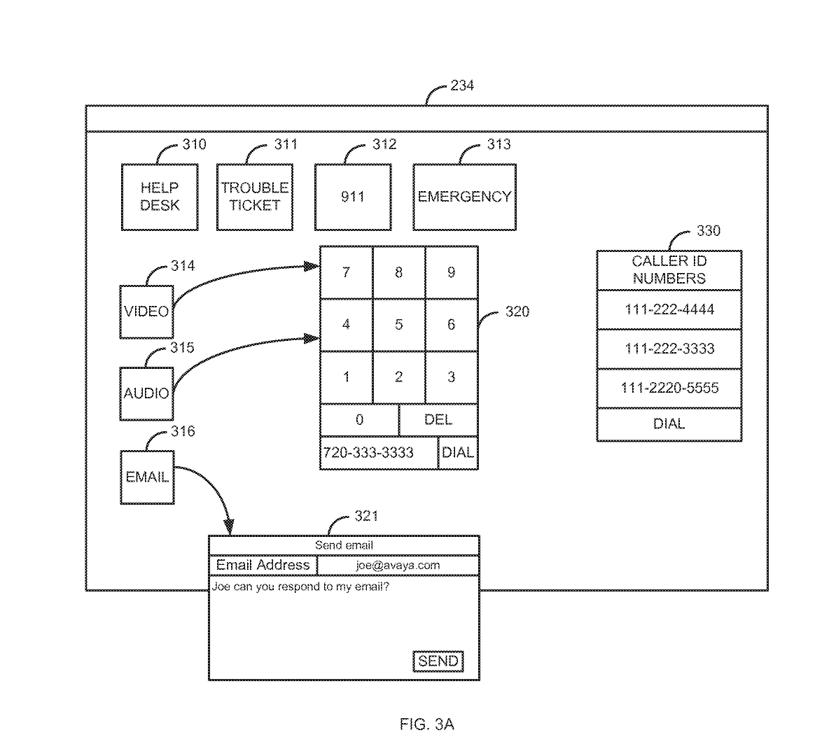

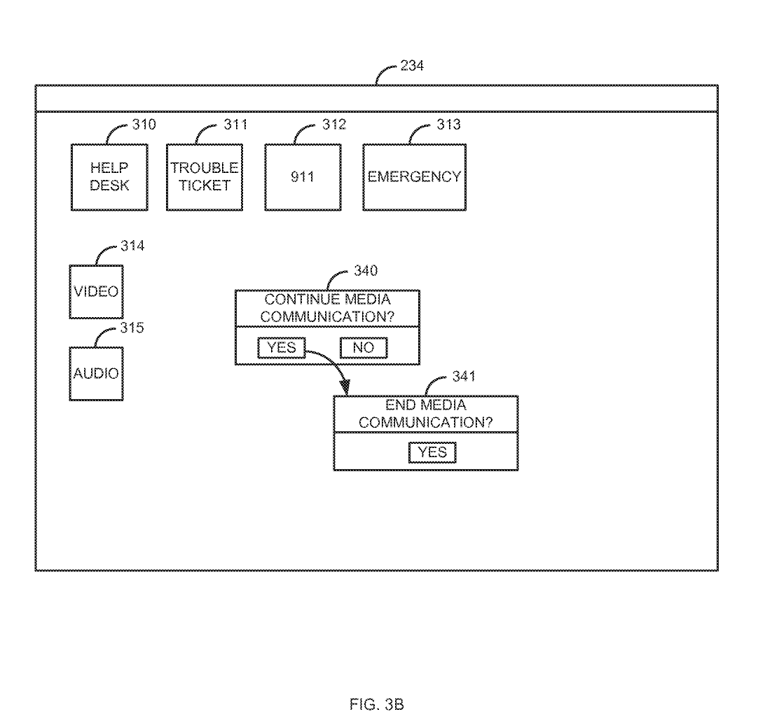

FIG. 3 is a diagram of an exemplary alternative communication interface 234. If the virtual communication channel goes down and/or cannot be established (or based on other reasons) alternative communication interface 234 can be displayed to the user of virtual desktop 130.

Alternative communication interface 234 is shown as an interactive graphical user interface. Alternative communication interface 234 comprises help desk button 310, trouble ticket button 311, 911 button 312, emergency button 313, video button 314, audio button 315, email button 316, and caller ID list 330. The various buttons 310-316 and caller ID list 330 can be displayed in different views besides those shown in FIG. 3. Buttons 310-316 can be, but are not limited to, icons, menus, and lists. Various combinations of buttons 310-316 and caller ID list 330 may or may not be included in alternative communication interface 234 based on user configuration(s), system configuration(s), supported feature(s), and the like. For example, alternative communication interface 234 may not include help desk button 310 and trouble ticket button 311 if there are no help desk or trouble ticket services. Likewise, video button 314 may not be displayed if the system does not support video communications. In a simplified embodiment, only 911 button 312 may be displayed. In addition to buttons 310-316 and caller ID list 330, other buttons, lists, icons, and the like may be displayed based on supported features in alternative communication interface 234. For example, a button to support text media such as Instant Messaging could be displayed to provide media communications using Instant Messaging.

Alternative communication interface 234 also comprises keypad 320 and email window 321. Keypad 320 allows the user to make voice and/or video calls. Keypad 320 is shown with primarily numeric keys. In other embodiments, keypad 320 can include all or some of the keys in a standard keyboard. Email window 321 allows the user to establish and send email communications (text media communications). One skilled in the art would recognize that similar windows may be displayed and used to send other types of text communications such as Instant Messaging.

Buttons 310-313 are used to provide media communication(s) on the alternative communication channel. For instance, the user can select help desk button 310 to send a text message or to establish a voice/video communication to a help desk. Similarly, the user can send a text message and/or set up an audio/video call to generate a trouble ticket, a 911 call, and an emergency call by respectively clicking on trouble ticket button 311, 911 button 312, and emergency button 313. The type of media communication that is generated when the user selects one of buttons 310-313 can be user-defined, administered, fixed, and the like. For example, if the user selects 911 button 312, a 911 voice call can be automatically established on the alternative communication channel. Other alternatives can include establishing multiple communications based on selecting one of buttons 310-313. For instance, when the user selects the trouble ticket button 311, a video communication can be established along with the ability to send text (by providing an interface similar to email window 321). Alternatively, buttons 310-313 can be push-to-talk buttons that allow the user to establish a voice communication.

Video button 314 is used to initiate a video communication. In an exemplary embodiment, keypad 320 is displayed to the user when the user selects video button 314. The user then enters a number to dial in order to make a video communication. Keypad 320 can include alpha numeric characters to dial numbers that contain alpha or other characters. Other alternatives may allow the user to enter information from a keyboard.

Audio button 315 is used to initiate an audio communication. In this exemplary embodiment, keypad 320 is displayed to the user when the user selects audio button 315. The user then enters the necessary numbers in order to establish an audio communication with a communication device 101.

Email button 316 is used to initiate an email communication (text media communication). In this exemplary embodiment, email window 321 allows the user to type in an email and an email address, and send an email. Email window 321 is a simplified email system. Email window 321 can also include full functionality that is provided in many email systems, such as receiving emails, calendaring, contacts, tasks, and the like.

Caller ID list 330 displays a list of caller ID numbers that allows the user to make calls to people who have previously called. When calls are received (via the alternative communication channel or the virtual communication channel) the caller ID numbers are stored in caller ID list 330. A user can select a number from caller ID list 330 and make a call. Caller ID list 330 can contain the numbers of different people that the user has previously called as well.

FIG. 3B is a diagram of another exemplary alternative communication interface 234. In an alternative embodiment, alternative communication interface 243 comprises buttons 310-315. Buttons 310-315 can be used in like manner as described in FIG. 3A. In this exemplary embodiment, alternative communication interface 243 does not contain email button 316. However, alternative communication could also comprise email button 316.

If there is an existing media communication in the virtual communication channel and the virtual communication channel cannot be sustained, alternative communication interface 234 can display continue media window 340. Continue media window 340 gives a user the ability to reestablish the media communication in the alternative communication channel. If the user selects the NO button in the continue media communication window 340, the media communication is dropped.

Media controller 132 can reestablish the media communication in various ways. For example, media controller can store the telephone number of communication device 101 when the media communication was established on the virtual communication channel. Media controller 132 can store other types of information that allow media controller 132 to reestablish the media communication in the alternative communication channel, such as storing an Internet Protocol (IP) address of communication device 101, storing a URL that points to communication device 101, storing a server address, and the like.

If the user chooses to continue the media communication by selecting the YES button in the continue media communication window 340, the media communication is reestablished in the alternative communication channel. When the user selects the YES button in continue media communication window 340, end media communication window 341 is displayed. The user can select the YES button in the end media communication window 341 to end the media communication. Alternatively, if the other user on the media communication terminates the media communication, end media communication window 341 can be automatically closed.

For example, if the user has established an audio communication from virtual interface 235 to communication device 101A and, at a later point in time, the virtual communication channel cannot be sustained, the user is presented with continue media communication window 340. The user can select the YES button in continue media communication window 340 to reestablish the audio communication in the alternative communication channel. Media controller 132 dials a stored telephone number to reestablish the audio communication on the alternative communication channel. Once the audio communication is established with communication 101A (i.e., the user hears the other parties on the call or sees and hears the other parties in a video call), the user can select the YES button in the end media communication window 341 to end the audio communication.

In yet another embodiment, if the media communication has been established prior to determining that the virtual communication channel cannot be sustained, the media communication can be automatically reestablished. If the media communication is automatically reestablished, end media communication window 341 is displayed instead of continue media communication window 340.

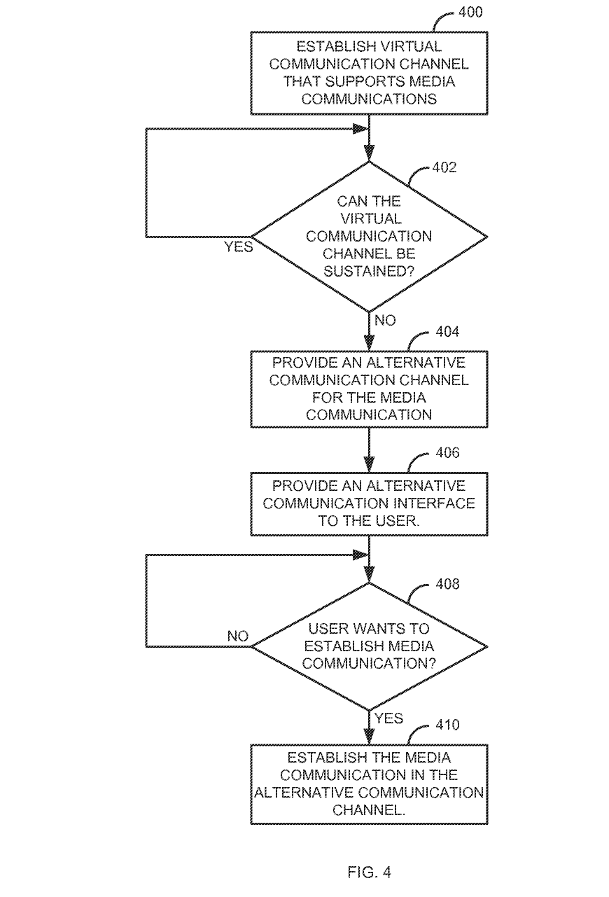

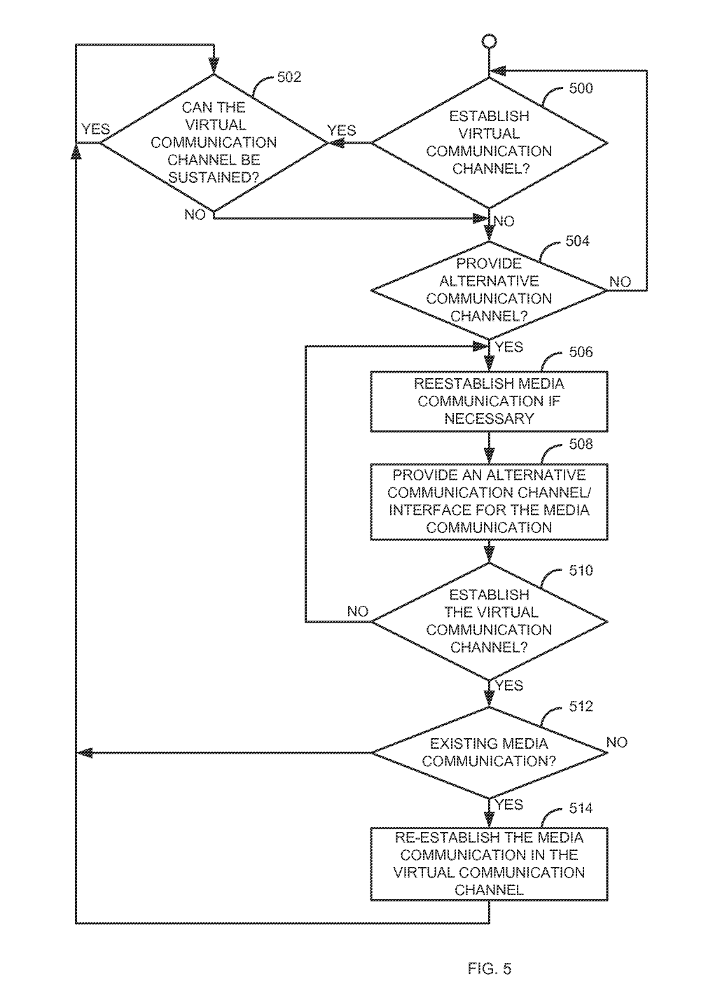

FIG. 4 is a flow diagram of a method for providing an alternative communication channel in a virtual environment. Illustratively, communication device 101, virtual server 120, virtual desktop 130, virtual controller 131, and media controller 132 are stored-program-controlled entities, such as a computer or processor, which performs the method of FIGS. 4-5 and the processes described herein by executing program instructions stored in a tangible computer readable storage medium, such as a memory or disk.

Virtual controller 131 establishes 400 a virtual communication channel between virtual controller 131 and virtual server 120. The virtual communication channel supports media communications, such as audio communications, video communications, text communications, and the like. Virtual controller 131 determines if the virtual communication channel can be sustained in step 402. If the virtual communication channel can be sustained in step 402, the process continues at step 402. If the virtual communication channel cannot be sustained in step 402, media controller 132 provides 404 an alternative communication channel for a media communication. Media controller 132 provides 406 alternative communication interface 234 so the user can make a media communication on the alternative communication channel.

Media controller 132 determines in step 408 if the user wants to establish a media communication on the alternative communication channel. For example, the user wants make an emergency call or 911 call using alternative communication interface 234 (by selecting the 911 button 312). If the user does not want to establish a media communication, the process repeats step 408. If the user wants to establish a media communication, media controller 132 establishes 410 the media communication in the alternative communication channel.

FIG. 5 is a flow diagram of a method that automatically reestablishes a media communication once the virtual communication channel is reestablished. The process begins in step 500 when virtual controller 131 determines if a virtual communication channel can be established with virtual server 120. If the virtual communication channel cannot be established in step 500, the process goes to step 504. Otherwise, if the virtual communication channel can be established in step 500, virtual controller 131 determines in step 502 if the virtual communication channel can be sustained. If the virtual communication channel can be sustained in step 502, the process repeats step 502.

Otherwise, if the virtual communication channel cannot be sustained in step 502 or the virtual communication channel cannot be established in step 500, media controller 132 determines in step 504 if an alternative communication channel can be provided. If the alternative communication channel cannot be provided in step 504, the process goes to step 500.

If the alternative communication channel can be provided in step 504, media controller 132 reestablishes 506 the media communication if necessary. For example, if a media communication (voice, video, and/or text) was established using virtual interface 235 via the virtual communication channel prior to step 502. Media controller 132 provides 508 the alternative communication channel and the alternative communication interface 234.

Virtual controller 131 determines in step 510 if the virtual communication channel can now be established. If the virtual communication channel cannot be established in step 510, the process goes to step 506. Otherwise, if the virtual communication channel can be established in step 510, the process determines if there is an existing media communication in the alternative communication channel in step 512. If there is not an existing media communication in step 512, the process goes to step 502. Otherwise, if there is an existing media communication in step 512, the media communication is reestablished 514 in the virtual communication channel and the process goes to step 502. In one embodiment, the virtual communication channel is reestablished automatically. Alternatively, the continue media communication window 340 can be presented to the user. This allows the user to reestablish the media communication if he/she wants to.

Herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Herein, the term “a,” “an,” or another entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated Figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
establishing a virtual communication channel between a virtual server and a virtual controller, wherein the virtual communication channel comprises the ability to support a media communication;
determining in the virtual controller that the virtual communication channel cannot be sustained; and
responsive to determining that the virtual communication channel cannot be sustained, providing by a media controller, an alternative communication channel for the media communication.

2. The method of claim 1, wherein the media communication is at least one of an audio communication, a video communication, and a text communication.

3. The method of claim 1, wherein determining that the virtual communication channel cannot be sustained comprises at least one of the following:
i. determining that the virtual communication channel went down;
ii. determining that the virtual communication channel cannot be established; and
iii. determining that the virtual communication is down by not being able to establish the media communication.

4. The method of claim 1, wherein providing the alternative communication channel further comprises providing in a graphical user interface an alternative communication interface to establish the alternative communication channel.

5. The method of claim 4, wherein the alternative communication interface comprises a push to talk button that allows a user to do at least one of the following: to call a help desk, to generate a trouble ticket, to make a 911 call, and to make an emergency call.

6. The method of claim 4, wherein the media communication is an audio or a video communication and the alternative communication interface comprises a keypad, and an interface for establishing one or both of the video or the audio communication.

7. The method of claim 4, further comprising the step of providing a caller ID list in the alternative communication interface that is used to make calls on the alternative communication channel.

8. The method of claim 4, wherein the media communication is a text communication and the alternative communication interface comprises a window to enter text for the text communication.

9. The method of claim 1, wherein providing the alternative communication channel further comprises establishing the media communication in the alternative communication channel and further comprising the steps of:
prior to determining that the virtual communication channel cannot be sustained, establishing the media communication in the virtual communication channel;
determining in the virtual controller that the virtual communication channel can be sustained; and
responsive to determining that the virtual communication channel can be sustained, reestablishing the virtual communication channel and automatically reestablishing the media communication in the virtual communication channel.

10. The method of claim 9, wherein responsive to determining that the virtual communication channel cannot be sustained, providing a continue media communication window that gives a user the ability to reestablish the media communication in the alternative communication channel.

11. A system comprising:
a virtual controller configured to establish a virtual communication channel between a virtual server and the virtual controller, and to determine that the virtual communication channel cannot be sustained, wherein the virtual communication channel comprises the ability to support a media communication; and
a media controller configured to provide an alternative communication channel for the media communication in response to determining that the virtual communication channel cannot be sustained.

12. The system of claim 11, wherein the media communication is at least one of an audio communication, a video communication, and a text communication.

13. The system of claim 11, wherein the virtual controller is configured to determine that the virtual communication channel cannot be sustained in at least one of the following ways:
i. determine that the virtual communication channel went down;
ii. determine that the virtual communication channel cannot be established; and
iii. determine that the virtual communication is down by not being able to establish the media communication.

14. The system of claim 11, wherein providing the alternative communication channel further comprises a graphical user interface configured to provide in an alternative communication interface to establish the alternative communication channel.

15. The system of claim 14, wherein the alternative communication interface comprises a push to talk button that allows a user to do at least one of the following: to call a help desk, to generate a trouble ticket, to make a 911 call, and to make an emergency call.

16. The system of claim 14, wherein the media communication is an audio or a video communication and the alternative communication interface comprises a keypad, and an interface for establishing one or both of the video or the audio communication.

17. The system of claim 14, wherein the alternative communication interface is further configured to provide a caller ID list that is used to make calls on the alternative communication channel.

18. The system of claim 14, wherein the media communication is a text communication and the alternative communication interface comprises a window to enter text for the text communication.

19. The system of claim 11, wherein the media controller is configured to provide the alternative communication channel by establishing the media communication in the alternative communication channel; and
the virtual controller is further configured to establish the media communication in the virtual communication channel prior to determining that the virtual communication channel cannot be sustained and determine that the virtual communication channel can be sustained and responsive to determining that the virtual communication channel can be sustained, reestablishing the virtual communication channel and automatically reestablish the media communication in the virtual communication channel.

20. The method of claim 19, further comprising an alternative communication interface that comprises a continue media communication window that is provided to a user in response to determining that the virtual communication cannot be sustained and wherein the continue media communication window that gives a user the ability to reestablish the media communication in the alternative communication channel.
